(19) United States
(12) Patent Application Publication
(10) Pub. No.: US 2018/0201851 A1
(43) Pub. Date: Jul. 19, 2018

(54) SYSTEM AND METHOD FOR CHEMICAL LOOPING

(71) Applicant: GENERAL ELECTRIC TECHNOLOGY GMBH, BADEN (CH)

(72) Inventor: FREDERIC VITSE, WEST HARTFORD, CT (US)

(73) Assignee: GENERAL ELECTRIC TECHNOLOGY GMBH, BADEN (CH)

(21) Appl. No.: 15/409,905

(22) Filed: Jan. 19, 2017

(51) Int. Cl. C10J 3/72; C01B 3/02; C01B 3/34

(52) U.S. Cl. CPC C10J 3/725; C01B 3/02; C01B 3/344; C10J 2300/093; C10J 2300/0996; C01B 2203/84; C10J 2300/1807; C01B 2203/0255; C01B 2203/0425; C01B 2203/0485; C01B 2203/1241; C10J 2300/0983

(57) ABSTRACT

A method for chemical looping includes the steps of introducing a fuel and an oxygen carrier to a reducer, wherein in the reducer the fuel reacts with the oxygen carrier to produce a gas containing a sulfur-containing species, within the reducer, capturing the sulfur-containing species with the oxygen carrier, transporting the oxygen carrier with the sulfur-containing species to an oxidizer, within the oxidizer, releasing the sulfur-containing species via an oxidation reaction, within the oxidizer, recapturing the sulfur-containing species with the oxygen carrier, and transporting the oxygen carrier with the sulfur-containing species back to the reducer. The oxygen carrier is a blend comprising at least one metal oxide and at least one calcium-containing species.

### GOVERNMENT RIGHTS

This invention was made with Government support under Contract Number DEFE0025073 awarded by the Department of Energy. The Government has certain rights in this invention.

### BACKGROUND

### Technical Field

Embodiments of the invention relate generally to power generation and, more particularly, to a system and method for improving the efficiency and reducing emissions of a chemical looping system.

### Discussion of Art

Chemical looping systems utilize a high temperature process whereby solids such as calcium or metal-based compounds, for example, are “looped” between a first reactor, called an oxidizer, and a second reactor, referred to as a reducer. In the oxidizer, oxygen from injected air is captured by the solids in an oxidation reaction. The captured oxygen is then carried by the oxidized solids to the reducer to be used for combustion or gasification of a fuel such as coal. After a reduction reaction in the reducer, the reacted solids, and, potentially, some unreacted solids, are returned to the oxidizer to be oxidized again, and the cycle repeats.

In the combustion or gasification of a fuel, such as coal, a product gas is generated. This gas typically contains pollutants such as carbon dioxide (CO₂), sulfur dioxide (SO₂) and sulfur trioxide (SO₃). The environmental effects of releasing these pollutants to the atmosphere have been widely recognized, and have resulted in the development of processes adapted for removing the pollutants from the gas generated in the combustion of coal and other fuels.

Existing chemical looping systems typically require significant post-combustion treatment systems for limiting emissions of particulate matter and certain gas species such as CO₂, SO₂, SO₃. Moreover, with calcium-based systems, solids/oxygen carrier cyclic capacity is known to degrade as side reactions releasing SO₂ occur under cyclic conditions between a reducer and an oxidizer. With metal oxide based systems, cyclic capacity loss occurs by, for example, sintering, attrition, poisoning, etc.

In view of the above, there is a need for a chemical looping system that minimizes the need for post-combustion treatment of combustion gases, reduces emissions, and reduces overall oxygen demand of the system.

### BRIEF DESCRIPTION

In an embodiment, a method for chemical looping is provided. The method includes the steps of introducing a fuel and an oxygen carrier to a reducer, wherein in the reducer the fuel reacts with the oxygen carrier to produce a gas containing a sulfur-containing species, within the reducer, capturing the sulfur-containing species with the oxygen carrier, transporting the oxygen carrier with the sulfur-containing species to an oxidizer, within the oxidizer, releasing the sulfur-containing species via an oxidation reaction, within the oxidizer, recapturing the sulfur-containing species with the oxygen carrier, and transporting the oxygen carrier with the sulfur-containing species back to the reducer. The oxygen carrier is a blend comprising at least one metal oxide and at least one calcium-containing species.

In another embodiment, a method for chemical looping is provided. The method includes the steps of, within a reducer, adsorbing at least one sulfur-containing species on an oxygen carrier, transporting the oxygen carrier to an oxidizer, within the oxidizer, desorbing the at least one sulfur-containing species as sulfur dioxide, within the oxidizer, recapturing at least a portion of the sulfur dioxide with the oxygen carrier, and transporting the oxygen carrier back to the reducer. The oxygen carrier is a mixture containing a metal oxide and a calcium-containing species.

In yet another embodiment, a system for chemical looping is provided. The system includes a reducer in which a fuel reacts with an oxygen carrier to produce reaction products including at least a sulfur-containing species, and an oxidizer in fluid communication with the reducer for supplying the oxygen carrier to the reducer after an oxidizing reaction in the oxidizer, and for receiving the oxygen carrier from the reducer after a reduction reaction in the reducer. In the reducer the sulfur-containing species is adsorbed on the oxygen carrier. In the oxidizer the sulfur-containing species is desorbed as sulfur dioxide and recaptured with the oxygen carrier for recycling to the reducer. The oxygen carrier is a mixture containing a metal oxide and a calcium-containing species.

### DRAWINGS

The present invention will be better understood from reading the following description of non-limiting embodiments, with reference to the attached drawings, wherein below:

FIG. 1 is a schematic illustration of a chemical looping system according to an embodiment of the invention.

FIG. 2 is a graph illustrating the effect of an oxygen carrier comprised of ilmenite on the amount of SO₂ exiting the system.

FIG. 3 is a graph illustrating the effect of an oxygen carrier comprised of ilmenite and aragonite on the amount of SO₂ exiting the system.

FIG. 4 is a graph 400 illustrating gas fuel conversion test data for various oxygen carriers in the presence of SO₂ and H₂S in the reducer

### DETAILED DESCRIPTION

Reference will be made below in detail to exemplary embodiments of the invention, examples of which are illustrated in the accompanying drawings. Wherever possible, the same reference characters used throughout the drawings refer to the same or like parts. While embodiments of the invention are suitable for use in a power generation process, other applications are also contemplated including but not limited to gasification processes such as, but not limited to, those used to produce syngas and those used to sequester carbon dioxide.

As used herein, “operatively coupled” refers to a connection, which may be direct or indirect. The connection is not necessarily a mechanical attachment. As used herein, “fluidly coupled” or “fluid communication” refers to an arrangement of two or more features such that the features are connected in such a way as to permit the flow of fluid between the features and permits fluid transfer. As used herein, “solids” means solid particles intended for use in a combustion process or a chemical reaction such as, for example, coal particles or a metal oxide (e.g., calcium). “Solids” is also referred to herein as an oxygen carrier.

Embodiments of the invention relate to a chemical looping system and method that utilizes an oxygen carrier/solids that are capable of cycling a sulfur-containing species, such as SO₂, between a reducer and oxidizer of the system to enhance the conversion of both gaseous and solid fuels. The method includes introducing a fuel and an oxygen carrier to a reducer, wherein in the reducer the fuel reacts with the oxygen carrier to produce a gas containing a sulfur-containing species, within the reducer, capturing the sulfur-containing species with the oxygen carrier, transporting the oxygen carrier with the sulfur-containing species to an oxidizer, within the oxidizer, releasing the sulfur-containing species via an oxidation reaction, within the oxidizer, recapturing the sulfur-containing species with the oxygen carrier, and transporting the oxygen carrier with the sulfur-containing species back to the reducer. The oxygen carrier may be a blend comprising at least one metal oxide and at least one calcium-containing species.

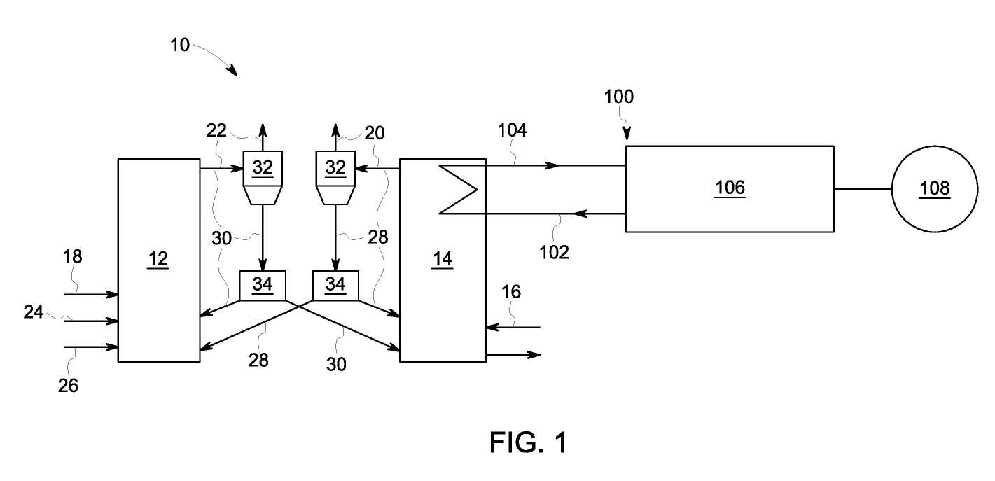

Referring to FIG. 1, a calcium-based chemical looping system 10 of a chemical looping-based power plant according to an exemplary embodiment is illustrated. The system 10 includes a first loop having a reducer 12, and a second loop having an oxidizer 14. Air 16 is supplied to the oxidizer 14, and a calcium-based oxygen carrier such as, for example, calcium sulfide (CaS) is oxidized therein to produce a calcium sulfate (CaSO₄). The CaSO₄ is supplied to the reducer 12, and acts as a carrier to deliver oxygen and heat to fuel 18 (such as coal, for example) supplied to the reducer 12. As a result, the oxygen delivered to the reducer 12 interacts with the coal 18 in the reducer 12. Reduced CaS, is then returned to the oxidizer 14 to again be oxidized into CaSO₄, and the cycle described above repeats. Flue gas including nitrogen gas (N₂) 20, extracted from the oxidizer by a gas/solids separation device such as a cyclone, as well as heat resulting from the oxidation, exit the oxidizer 14 through a standpipe and seal device to either return to the oxidizer or reducer, such as to the oxygen carrier. Likewise, a gas 22 produced during reduction in the reducer 12 exits the reducer 12.

As shown in FIG. 1, while air 16 is supplied to the oxidizer 14, as described above, waste 20 such as ash and/or excess calcium sulfate (CaSO₄), are removed from the oxidizer 14 for disposal in an external facility (not shown). The coal 18, as well as calcium carbonate (CaCO₃) 24 and recirculated steam 26, are supplied to the reducer 12 for a reduction reaction therein.

In operation, a series reduction reaction occurs within the reducer 12 among oxygen from the oxygen carrier and the coal 18, the CaCO₃ 24, and CaSO₄ 28, and produces calcium sulfide (CaS) 30, which is separated by a gas/solids separator 32, such as a cyclone separator 32, and is thereafter supplied to the oxidizer 14 through, for example, a seal pot control valve (SPCV) 34. A portion of the CaS and other solids 30, based upon CL plant load, for example, is recirculated to the reducer 12 by the SPCV 34, as shown in FIG. 1. In addition, the separator separates the flue gas 22, e.g., CO₂ and other emissions such as SO₂ from the CaS 30.

The CaS 30 is oxidized in an oxidation reaction in the oxidizer 14, thereby producing the CaSO₄ 28 which is separated from flue gas 20 by a separator 32 and is supplied back to the reducer 12 via a SPCV 34. A portion of the CaSO₄ 28 and CaS may be recirculated back to the oxidizer 14 by the SPCV 34 based upon CL plant load, for example. The oxidation reaction also produces heat which can be utilized in other processes. For example, as illustrated in FIG. 1, in an embodiment, a thermal loop 100 may be integrated with the system 10 to generate power. In particular, the heat produced by the oxidation reaction can be utilized in a steam/water generating device 102 to generate steam 104 which is then used to drive a steam turbine 106 which, in turn, drives a power generator 108.

With further reference to FIG. 1, in an embodiment, the oxygen carrier that is circulated between the reducer 12 and the oxidizer 14 may be a blend of one or more metal oxide and calcium containing species. For example, metal oxides associated with, but not limited to, the elements Iron (Fe), Ni (Nickel), Manganese (Mn), Cobalt (Co), Chromium (Cr), and Molybdenum (Mo) may be utilized. Corresponding metal ores are also contemplated as suitable carriers. In addition, supported metal oxides, supported by, for example, aluminum oxide (Al₂O₃), titanium dioxide (TiO2), cerium oxide (CeO₂), lanthanum oxide (La₂O₃), vanadium pentoxide (V₂O₅), and zeolites may be used as suitable carriers. In an embodiment, the calcium containing species may include, but are not limited to, limestone, dolomite, and lime.

In an embodiment, the oxygen carrier may be a blend of ilmenite and aragonite (such as in the form of limestone). In an embodiment, the oxygen carrier may comprise about 90 to about 100 weight percent of limestone and about 0 to about 10 weight percent of ilmenite (e.g., a ratio of limestone/ilmenite of 90/10 by weight). In another embodiment, the oxygen carrier may comprise about 80 to about 90 weight percent of limestone and about 10 to about 20 weight percent of ilmenite (e.g., a ratio of limestone/ilmenite of 80/20 by weight). In another embodiment, the oxygen carrier may comprise about 60 to about 80 weight percent of limestone and about 20 to about 40 weight percent of ilmenite (e.g., a ratio of limestone/ilmenite of 60/40 by weight). In yet another embodiment, the oxygen carrier may comprise about 0 to about 10 weight percent of limestone and about 90 to about 100 weight percent of ilmenite (e.g., a ratio of limestone/ilmenite of 10/90 by weight).

In general better sulfur management is achieved with high limestone concentrations and better performance/conversion is achieved with high ilmenite concentrations. However, when the partial pressure of SO2 is maintained above 2000 ppmv, as discussed below, (and recaptured in a polisher or downstream desulfurization system), the difference in performance can significantly reduced between different blends.

In use, a sulfur-containing fuel such as, for example, pulverized coal 18, is fed to the reducer 12 of the chemical looping system 10. Ilmenite is an oxygen carrier capable of oxidizing sulfur in the fuel 18 to SO₂. SO₂, in the presence of a reducing gas or by directly reacting with carbon in the fuel, is reduced and adsorbed to/collected on the ilmenite. At least some unreacted SO₂ is also adsorbed by calcined limestone. The reduced sulfur-containing species is then transported to the oxidizer 14 where oxidation occurs. In the oxidizer 14, at least some SO₂ is released in the gas phased and at least some SO₂ is recaptured by calcined limestone in the presence of oxygen. The oxidized sulfur-containing species are then transported back to the reducer 12 where the cycle is iterated.

The sulfur-containing species formed in the reducer 12, in addition to being a product of combustion of the solid fuel 18, can also come from the oxygen carrier (CaSO4/CaS) itself. In particular, the sulfur-containing species can be released as the oxidation of the fuel 18 takes place, and can be recaptured by the secondary oxygen carrier (e.g., ilmenite, etc.) in the manner described above. This may be more prevalent as the calcium-containing species loads up over cycling time and ends up releasing sulfur-containing species. In particular, in the reducer 12, the reducing atmosphere may not be sufficient to prevent SO₂ release from the oxygen carrier. For example, low carbon and low hydrogen in the reducer may contribute to SO₂ release from the oxygen carrier, as shown by the following reactions, respectively: CaSO₄+CO=>CaO+CO₂+SO₂, CaSO₄+H₂=>CaO+H₂O+SO₂. As discussed above, the released SO₂ acts as an oxidizer in the gas phase (or as an adsorbed species elsewhere on the oxygen carrier) and is recaptured. The oxygen carrier make up therefore must be managed accordingly.

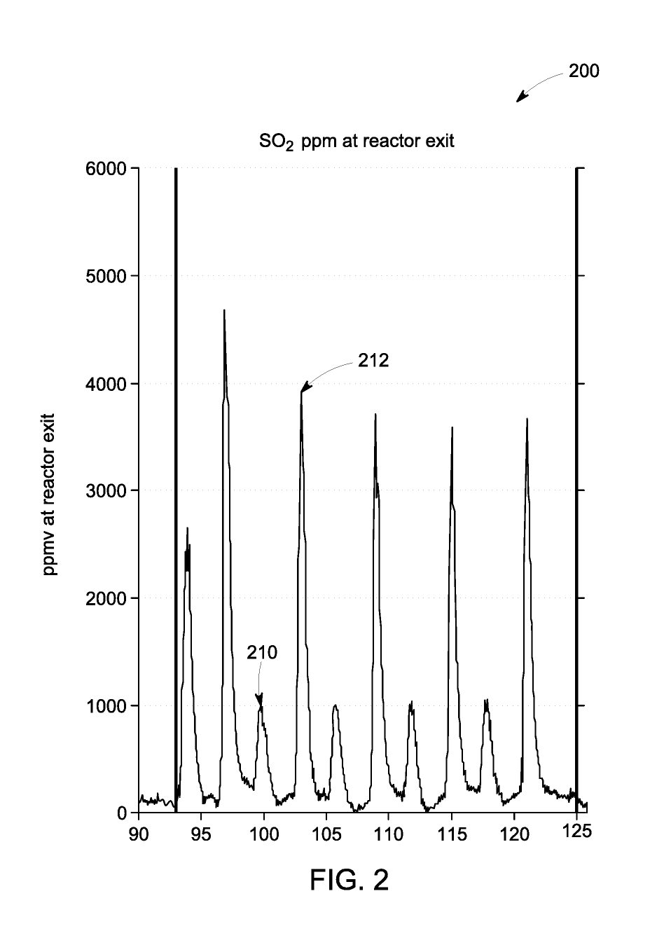

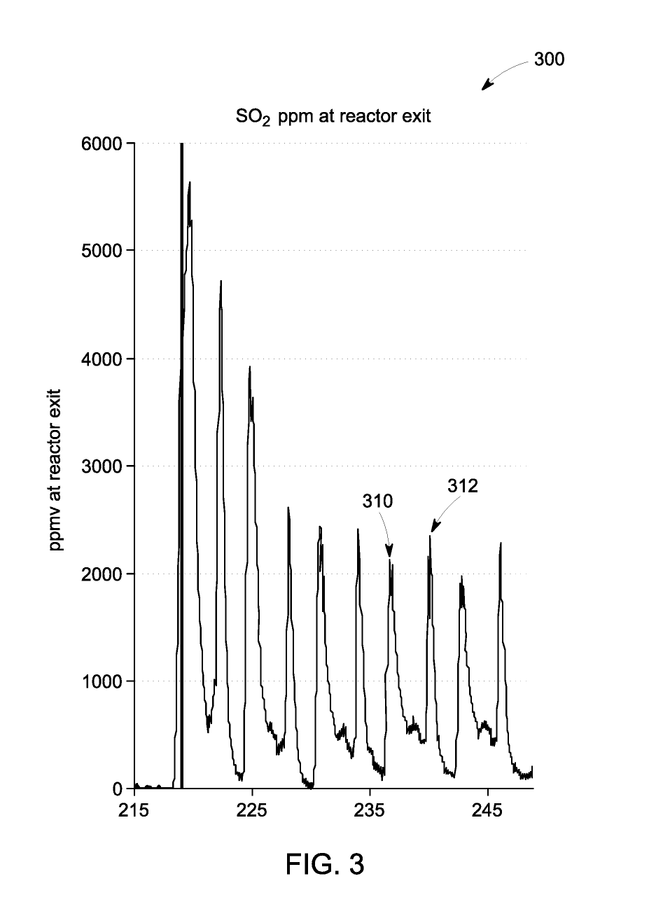

Turning now to FIGS. 2 and 3, the effect of an oxygen carrier comprised of ilmenite, and ilmenite and aragonite, respectively, on the amount of SO₂ exiting the system 10 is demonstrated. The system 10 was tested under the following conditions: a 15% CO in N₂ balance in the reducer, a 20% O2 in N₂ balance in the oxidizer, and at 1850° F. Referring first to FIG. 2, graph 200 shows sulfur dioxide concentration (in parts-per-million by volume) at the reducer product gas exit and oxidizer product gas exit (i.e., in streams 22, 20) where SO₂ is fed to the reducer 12 at 2000 ppmv, and where ilmenite only is used as the oxygen carrier. SO₂ fed to the reducer 12 at 2000 ppmv in the presence of CO as a reducing gas is adsorbed by the ilmenite in the reducer 12 and brought to oxidizing conditions. During the oxidation stage, SO₂ is released. As shown therein, the peak SO₂ concentration 210 at the reducer exit was found to be approximately 1000 ppmv. As also shown therein, the peak SO₂ concentration 212 at the oxidizer exit was found to be approximately 3750 ppmv.

Referring now to FIG. 3, graph 300 shows sulfur dioxide concentration (in parts-per-million by volume) at the reducer product gas exit and oxidizer product gas exit (i.e., in streams 22, 20) where SO₂ is fed to the reducer 12 at 2000 ppmv, under the same operating conditions in the reducer 12 and oxidizer 14 as that used in FIG. 2, but wherein an ilmenite and aragonite blend is used as the oxygen carrier (instead of only ilmenite).

As shown therein, when aragonite is added, SO₂ is further recaptured in the reducer 12 and cycled back to the oxidizer 14 where at least a portion of it is released. As shown therein, the peak SO₂ concentration 310 at the reducer exit was found to be approximately 2250 ppmv. As also shown therein, the peak SO₂ concentration 312 at the oxidizer exit was found to be approximately 2250 ppmv. The net concentration of SO₂ exiting the reducer 12 and oxidizer 14 indicates that sulfur-containing species accumulate within the system 10, rather than being released in large amounts through the product gas streams 20, 22 of the oxidizer 14 and reducer 12.

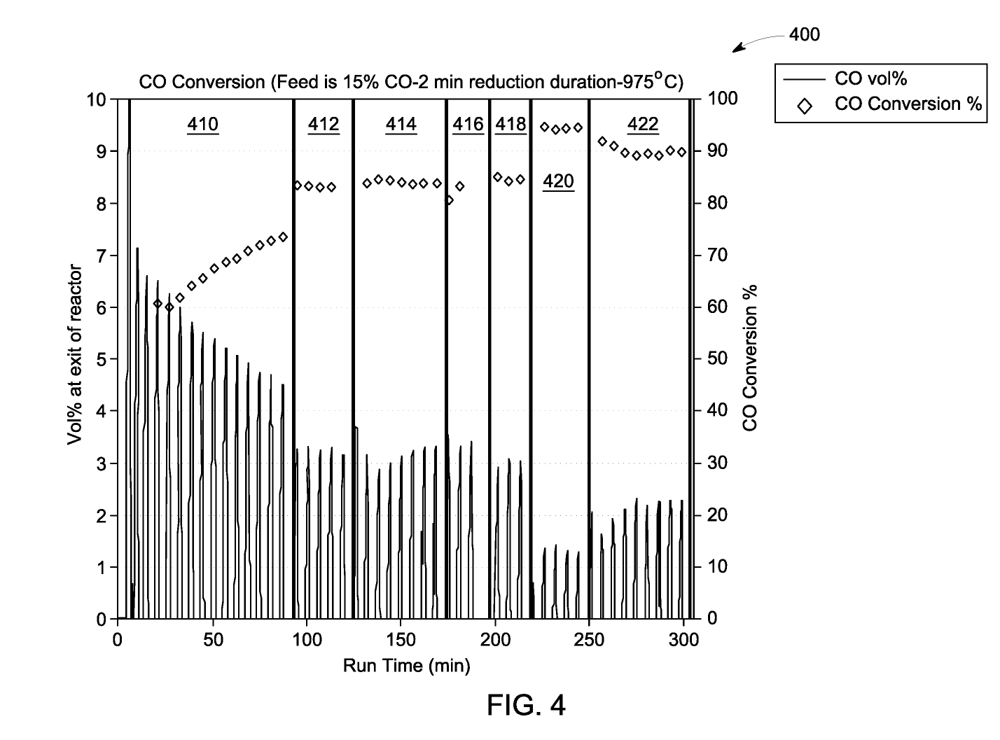

Turning now to FIG. 4, graph 400 shows gas fuel conversion test data for various oxygen carriers in the presence of SO₂ and H₂S in the reducer. Section 410 illustrates the process conditions resulting from the introduction of ilmenite only (30 g) in the reducer, section 412 illustrates the process conditions after the introduction of 2000 ppm of SO₂ in the reducer, section 414 illustrates the process conditions after the introduction of 1500 ppm H₂S in the reducer, section 416 illustrates the process conditions after the introduction of ilmenite only, section 418 illustrates the process conditions after the addition of limestone (in the form of aragonite) (3 g), section 420 illustrates the process conditions after the introduction of 2000 ppm of SO₂ in the reducer, and section 422 illustrates the process conditions after the introduction of 1500 ppm H₂S in the reducer. FIGS. 2 and 3, discussed above, correspond to the process conditions shown in sections 412 and 420, respectively, of FIG. 4. As demonstrated by the testing data shown in the graph of FIG. 4, adding limestone in the presence of SO₂ to an ilmenite oxygen carrier, the conversion of carbon dioxide in the gas can be increased from about 85% to about 95%.

As discussed above, sulfur-containing species produced from sulfur in the fuel fed to the reducer 12 or otherwise added to the system are adsorbed on an oxygen carrier (or oxygen carrier blend) and cycled back and forth between the reducer 12 and oxidizer 14 of the chemical looping system 10. In particular, in the oxidizer 14, sulfur-containing species are desorbed as SO₂, and at least partially recaptured by the oxygen carrier blend. Some oxidation of the sulfur-containing species may take place in its adsorbed form as well. The oxidizer oxygen carrier is then cycled back to the reducer 12 where the oxidized sulfur-containing species are released, reduced, and recaptured by the oxygen carrier. Some reduction of the sulfur-containing species may take place in its adsorbed form as well.

As indicated above, the system and method of the invention significantly enhances the conversion of gaseous and solid fuels during chemical looping by allowing gas-gas catalytic oxidative reactions to take place, as well as gas-solid oxidative reactions where the gas is the oxidizer and the solid is a fuel. In particular, the system and method of the invention take advantage of the capture and release of SO₂ as it is cycled between the reducer and the oxidizer for the purpose of reducing oxygen demand of the chemical looping process. Further to the above, the system and method of the invention increases carbon capture by enhancing the gasification of fuel (e.g., char), and improves the stability of the chemical looping processes, as a whole, via increased concentration of SO₂ in the reducer.

In an embodiment, the oxygen carrier blend may be tuned to minimize the oxygen demand of the product gas leaving the reducer and the fuel content of the solid outlet of the reducer. In addition, the oxygen carrier blend may be tuned to minimize sulfur loss to the gas products of the reducer and oxidizer by concentrating absorbed sulfur on a solid carrier that can be further purged from the process for downstream treatment, use or landfilling.

While the embodiments described above disclose the use of solid fuel such as, for example, pulverized coal, the invention is equally applicable to other fuels such as sour natural gas. In the case of sour natural gas, the sulfur containing species that is captured and recycled to the reducer is hydrogen sulfide (H₂S) and/or carbonyl sulfide (COS).

In an embodiment, a method for chemical looping is provided. The method includes the steps of introducing a fuel and an oxygen carrier to a reducer, wherein in the reducer the fuel reacts with the oxygen carrier to produce a gas containing a sulfur-containing species, within the reducer, capturing the sulfur-containing species with the oxygen carrier, transporting the oxygen carrier with the sulfur-containing species to an oxidizer, within the oxidizer, releasing the sulfur-containing species via an oxidation reaction, within the oxidizer, recapturing the sulfur-containing species with the oxygen carrier, and transporting the oxygen carrier with the sulfur-containing species back to the reducer. The oxygen carrier is a blend comprising at least one metal oxide and at least one calcium-containing species. In an embodiment, capturing the sulfur-containing species within the reducer includes adsorbing the sulfur containing species on the oxygen carrier. In an embodiment, releasing the sulfur-containing species within the oxidizer includes desorbing the sulfur-containing species. In an embodiment, the sulfur-containing species is sulfur dioxide. In an embodiment, the at least one metal oxide is ilmenite and the at least one calcium-containing species is aragonite. In an embodiment, the at least one metal oxide is in oxide of an element selected from the group consisting of iron, nickel, manganese, cobalt, chromium and molybdenum. In an embodiment, the at least one metal oxide is support by at least one of aluminum oxide, titanium dioxide, cerium oxide, lanthanum oxide, vanadium pentoxide and a zeolite. In an embodiment, the at least one sulfur-containing species is selected from the group consisting of limestone, dolomite and lime. In an embodiment, the fuel is a solid fuel. The fuel may be pulverized coal.

In another embodiment, a method for chemical looping is provided. The method includes the steps of, within a reducer, adsorbing at least one sulfur-containing species on an oxygen carrier, transporting the oxygen carrier to an oxidizer, within the oxidizer, desorbing the at least one sulfur-containing species as sulfur dioxide, within the oxidizer, recapturing at least a portion of the sulfur dioxide with the oxygen carrier, and transporting the oxygen carrier back to the reducer. The oxygen carrier is a mixture containing a metal oxide and a calcium-containing species. In an embodiment, the method may also include the step of feeding a fuel to the reducer, wherein in the reducer the fuel reacts with the oxygen carrier to produce a gas containing the at least one sulfur-containing species. In an embodiment, the metal oxide is in oxide of an element selected from the group consisting of iron, nickel, manganese, cobalt, chromium and molybdenum. In an embodiment, the sulfur-containing species is selected from the group consisting of limestone, dolomite and lime. In an embodiment, the metal oxide is support by at least one of aluminum oxide, titanium dioxide, cerium oxide, lanthanum oxide, vanadium pentoxide and a zeolite. In an embodiment, the metal oxide is ilmenite and the calcium-containing species is aragonite.

In yet another embodiment, a system for chemical looping is provided. The system includes a reducer in which a fuel reacts with an oxygen carrier to produce reaction products including at least a sulfur-containing species, and an oxidizer in fluid communication with the reducer for supplying the oxygen carrier to the reducer after an oxidizing reaction in the oxidizer, and for receiving the oxygen carrier from the reducer after a reduction reaction in the reducer. In the reducer the sulfur-containing species is adsorbed on the oxygen carrier. In the oxidizer the sulfur-containing species is desorbed as sulfur dioxide and recaptured with the oxygen carrier for recycling to the reducer. The oxygen carrier is a mixture containing a metal oxide and a calcium-containing species. In an embodiment, the metal oxide is ilmenite and the calcium-containing species is aragonite. In an embodiment, the metal oxide is in oxide of an element selected from the group consisting of iron, nickel, manganese, cobalt, chromium and molybdenum. In an embodiment, the sulfur-containing species is selected from the group consisting of limestone, dolomite and lime.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A method for chemical looping, comprising the steps of:
introducing a fuel and an oxygen carrier to a reducer, wherein in the reducer the fuel reacts with the oxygen carrier to produce a gas containing a sulfur-containing species;
within the reducer, capturing the sulfur-containing species with the oxygen carrier;
transporting the oxygen carrier with the sulfur-containing species to an oxidizer;
within the oxidizer, releasing the sulfur-containing species via an oxidation reaction;
within the oxidizer, recapturing the sulfur-containing species with the oxygen carrier; and
transporting the oxygen carrier with the sulfur-containing species back to the reducer;
wherein the oxygen carrier is a blend comprising at least one metal oxide and at least one calcium-containing species.

2. The method according to claim 1, wherein:
capturing the sulfur-containing species within the reducer includes adsorbing the sulfur containing species on the oxygen carrier.

3. The method according to claim 2, wherein:
releasing the sulfur-containing species within the oxidizer includes desorbing the sulfur-containing species.

4. The method according to claim 3, wherein:
the sulfur-containing species is sulfur dioxide.

5. The method according to claim 4, wherein:
the at least one metal oxide is ilmenite and the at least one calcium-containing species is aragonite.

6. The method according to claim 4, wherein:
the at least one metal oxide is in oxide of an element selected from the group consisting of iron, nickel, manganese, cobalt, chromium and molybdenum.

7. The method according to claim 4, wherein:
the at least one metal oxide is supported by at least one of aluminum oxide, titanium dioxide, cerium oxide, lanthanum oxide, vanadium pentoxide and a zeolite.

8. The method according to claim 6, wherein:
the at least one sulfur-containing species is selected from the group consisting of limestone, dolomite and lime.

9. The method according to claim 4, wherein:
the fuel is one of a solid fuel and sour natural gas.

10. The method according to claim 9, wherein:
the fuel is pulverized coal.

11. A method for chemical looping, comprising the steps of:
within a reducer, adsorbing at least one sulfur-containing species on an oxygen carrier;
transporting the oxygen carrier to an oxidizer;
within the oxidizer, desorbing the at least one sulfur-containing species as sulfur dioxide;
within the oxidizer, recapturing at least a portion of the sulfur dioxide with the oxygen carrier; and
transporting the oxygen carrier back to the reducer;
wherein the oxygen carrier is a mixture containing a metal oxide and a calcium-containing species.

12. The method according to claim 11, further comprising the step of:
feeding a fuel to the reducer;
wherein in the reducer the fuel reacts with the oxygen carrier to produce a gas containing the at least one sulfur-containing species.

13. The method according to claim 12, wherein:
the metal oxide is in oxide of an element selected from the group consisting of iron, nickel, manganese, cobalt, chromium and molybdenum.

14. The method according to claim 13, wherein:
the sulfur-containing species is selected from the group consisting of limestone, dolomite and lime.

15. The method according to claim 12, wherein:
the metal oxide is supported by at least one of aluminum oxide, titanium dioxide, cerium oxide, lanthanum oxide, vanadium pentoxide and a zeolite.

16. The method according to claim 12, wherein:
the metal oxide is ilmenite and the calcium-containing species is aragonite.

17. A system for chemical looping, comprising:
a reducer in which a fuel reacts with an oxygen carrier to produce reaction products including at least a sulfur-containing species; and
an oxidizer in fluid communication with the reducer for supplying the oxygen carrier to the reducer after an oxidizing reaction in the oxidizer, and for receiving the oxygen carrier from the reducer after a reduction reaction in the reducer;
wherein in the reducer the sulfur-containing species is adsorbed on the oxygen carrier;
wherein in the oxidizer the sulfur-containing species is desorbed as sulfur dioxide and recaptured with the oxygen carrier for recycling to the reducer; and
wherein the oxygen carrier is a mixture containing a metal oxide and a calcium-containing species.

18. The system of claim 17, wherein:
the metal oxide is ilmenite and the calcium-containing species is aragonite.

19. The system of claim 17, wherein:
the metal oxide is in oxide of an element selected from the group consisting of iron, nickel, manganese, cobalt, chromium and molybdenum.

20. The method according to claim 19, wherein:
the sulfur-containing species is selected from the group consisting of limestone, dolomite and lime.
